(19) United States
(12) Patent Application Publication
(10) Pub. No.: US 2024/0046392 A1
(43) Pub. Date: Feb. 8, 2024

(54) SYSTEM AND METHOD OF GENERATING EXAMS

(71) Applicant: EXAMIND AI INC., Vancouver (CA)

(72) Inventors: Gonzalo Tudela, North Vancouver (CA); Jun Oshika, Coquitlam (CA); Kenneth Henry MacKenzie, Sechelt (CA); Bradley Reed Skousen, Logan, UT (US)

(73) Assignee: EXAMIND AI INC., Vancouver (CA)

(21) Appl. No.: 18/366,166

(22) Filed: Aug. 7, 2023

Related U.S. Application Data
(60) Provisional application No. 63/396,109, filed on Aug. 8, 2022.

(51) Int. Cl. G06Q 50/20; H04L 67/50

(52) U.S. Cl. CPC G06Q 50/20; H04L 67/535

(57) ABSTRACT

The present invention provides systems and methods of generating and administering online exams that inherently deter cheating. It provides a method for generating an examination question. The method includes defining a parametric question template including a plurality of parameters, where each of the plurality of parameters has a plurality of possible values. Then receiving a request to generate a plurality of examinations utilizing the parametric question and generating a question by substituting one of the plurality of possible values for each of the plurality of parameters. Finally, generating an identifier of the question including a combination of the substituted possible values for each of the plurality of parameters of the question.

### CROSS-REFERENCE TO RELATED APPLICATIONS

This application claims priority to U.S. Provisional Application 63/396,109 filed Aug. 8, 2022, which is incorporated herein by reference in its entirety.

### FIELD OF THE INVENTION

The present invention pertains to the field of online examinations and in particular to systems and methods of generating and administering online examinations while inhibiting cheating.

### BACKGROUND

Examinations have been used for centuries in order to evaluate the competence of students, trades people, professional, employees, and other types of candidates. Traditionally, exams are administered in a particular place, such as a classroom, with hard copy exams being distributed to students, who would then have a set amount of time to complete the exam. A teacher, proctor, or invigilator would be tasked with ensuring that cheating didn't occur. Exam papers were then collected at the end of the exam for grading. This provided secure, but relatively rigid methods of administering examinations.

As time progressed, online exams became commonplace where a candidate would write an exam on a secure computer at an examination center. The exam would be done using software installed on the computer supplied by the exam center, time limits would be enforced, and candidates would often be limited on what items (such as calculators, cell phones, etc.) they could bring into the exam room. This system provides additional flexibility over the traditional approach while still making it difficult to cheat. However, this type of online exam is relatively expensive and cumbersome due the requirement of a secure location, secure computer, and usually, an invigilator of some type.

In the present day, the Internet and online learning has become ubiquitous, and it is common for students to attend classes and take exams entirely online. Furthermore, students or other candidates typically possess multiple computing devices including laptop computers, tablets, and cell phones. Given a number of candidates writing an exam in different locations, physical invigilation in no longer feasible while a number of websites have sprung up offering the ability of uploading both exam questions and their answers. Cheating has never been easier.

Online or digital examination has transformed how examinations are being conducted. Although digital examinations have their benefits, susceptibility to cheating has been a continuous challenge. For example, students may resort to impersonation, use devices (e.g., smart phones, smart watches, external storage) or other techniques (e.g., screen sharing) to cheat during examinations.

In order to combat cheating on exams several approaches are used. Proctoring software has been developed to prevent or report on cheating or other suspicious behavior, however, candidates are reluctant to install or use such invasive software on their computing devices and the restrictions provided by proctoring software is easily circumvented. Also, professors or others who author exams have been forced to regularly update and change exam questions, as many questions are leaked online. However, this often places a heavy burden on the exam authors.

Therefore, there is a need for improved systems and methods of generating and administering exams that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide systems and methods of generating and administering online exams that inherently deter cheating. In accordance with an aspect of the present invention, there is provided a method for generating an examination question. The method includes defining a parametric question template including a plurality of parameters, where each of the plurality of parameters has a plurality of possible values. Then receiving a request to generate a plurality of examinations utilizing the parametric question and generating a question by substituting one of the plurality of possible values for each of the plurality of parameters. Finally, generating an identifier of the question including a combination of the substituted possible values for each of the plurality of parameters of the question.

In accordance with another aspect of the present invention, there is provided a method for administering an examination including generating an examination for each of a plurality of candidates, where the examinations include a plurality of questions. Each of the plurality of questions of each of the examinations is generated by substituting one of a plurality of possible values for each of a plurality of parameters of each of the plurality of questions. Then generating an identifier for each of the examinations by combining the substituted possible values for each of the plurality of parameters of the plurality of questions, verifying that each of the identifiers is unique, and sending one of the examinations to each of the plurality of candidates.

Embodiments also include systems, including computing devices, for implementing the methods as described herein.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which;

FIG. 1 illustrates a flowchart of the preparation of questions and exams using parametric questions, according to an embodiment.

FIG. 2 illustrates a flowchart of the generations of questions and exams using parametric questions, according to an embodiment.

FIG. 3 illustrates a flowchart of the administrations of questions and exams using parametric questions, according to an embodiment.

FIG. 4 illustrates a parametric question, according to an embodiment.

FIG. 5 illustrates a computer interface for the creation of a parametric question, according to an embodiment.

FIG. 6 illustrates the creation of an identifier for questions and exams, according to an embodiment.

FIG. 7 a computer device, one of more of which may form an apparatus or system to perform any of the methods as described herein.

FIG. 8 illustrates an example of digital fingerprint, pixel watermark, according to an embodiment.

It will be noted that throughout the appended drawings, like features are identified by like reference numerals.

### DETAILED DESCRIPTION OF THE INVENTION

As used herein, the term examination or exam is used to describe any type of computer-based examination, test, quiz, set of questions, set of exercises that is administered to test a competency such as in a school, university, or college setting, or as part of a certification test or qualification. The terms examination and exam are used interchangeably. As used herein, a question or exam is given to a candidate, such as a student, who then attempts to answer the questions contained within the exam.

The term parametric question is used to define a question template or script that may contain a mix of fixed text, parameters, and possible correct and incorrect answers. A parametric question may be defined and later be used as a template to generate an arbitrary number of exam questions by substituting in different values for one or more of the parameters. Parametric questions may have various types as found in conventional exams. These types include multiple choice, multiple answers, matching, and fill in the blank type questions. Fill in the blank questions may allow instructors to specify answers using regular expression pattern matching techniques or computational logic. Exam questions generated from parametric questions may be paired with intelligent auto-grading algorithms to automatically grade one or more questions of an exam.

In some aspects, parametric questions may be defined or created without writing any code, e.g., in a drag-and-drop no-code environment. In some aspects, parametric questions may be created using artificial intelligence (AI) or AI assist. Defining parametric questions in such methods (e.g., without coding) differ from existing platforms such as PrairieLearn which require using a programming language (e.g., Python) and being a computer scientist to create these types of questions.

The term parameter may also be referred to as a variable and refers to text of a question where the value may change each time a question is generated from a parametric question. Parameters may fall into different broad categories such as “variables,” “math,” “text,” “lists,” “logic,” “loops,” “functions,” etc., that define a parameter independently, or define a parameter that is dependent on one or more other parameters.

The term identifier refers to a text, numeric, or other type of value that identifies a particular question or exam generated from parametric questions. The identifier may be value that is unique for all previous times a question or exam has been generated using that parametric question or may be sufficiently unique that the identifier can be used to identify a small number of generated questions or exams to enable the identification of one or a small number of candidates who received the question or exam associated with the identifier. In other words, every time a question is generated, a “permutation” of a question can be made unique by randomly assigning values that are substituted for the defined parameters. If the number of permutations is high enough then if a question is ever leaked, this uniqueness allows for the identification of the student who leaked the question. In embodiments, the identification of the student may be done through a reverse lookup process that matches the leaked question with previously generated permutations using fuzzy matching and similarity scores. An identifier may be generated using various text-based similarity algorithms such as by using a Jaccard Index, by using a term frequency-inverse document frequency (TF-IDF) measure, or by simply combining the parameter values of a generated question or exam, of a representation of the generated parameter values using a hash or similar mathematical means.

As used herein, the term “academic integrity score” refers to the number of unique permutations a parametric question has. A higher academic integrity score increases the difficulty of cheating on an exam containing the parametric questions by way of leaked exam content. In embodiments, a question's uniqueness is evaluated based on the number of values that the parameters of a question can take. For example, if a parametric question contains a single parameter that can have an integer value from 1 to 10 then ten unique questions can be generated. If a parametric question contains two parameters; one that can have an integer value from 1 to 10 and a second parameter that can be a text value selected from a list of 20 different values, then 200 unique questions can be generated. For a parametric question with a sufficiently large number of parameters and where at least one of the parameters can have any of a large number of values, there may be a substantial number (e.g., billions or trillions) of possible unique questions that may be generated.

Embodiments of the present invention provide a method for generating an examination question. The method includes defining a parametric question template including a plurality of parameters. Each of the plurality of parameters has a plurality of possible values. Then receiving a request to generate a plurality of examinations utilizing the parametric question. Also, generating a question by substituting one of the plurality of possible values for each of the plurality of parameters. The method also includes, generating an identifier of the question including a combination of the substituted possible values for each of the plurality of parameters of the question. The use of parametric questions allow the generation of an almost unlimited number of unique questions that may be used in exams. These embodiments may provide a unique exam to each candidate. If candidates are aware of this, they will be very reluctant to share their exam questions online as they may be identified if the question is found online and face various academic consequences. Furthermore, since each candidate writing the exam may have their own version, there is little benefit to searching for answers online as they will not exist.

Further embodiments include evaluating the parametric question to determine an academic integrity score based on a number of possible permutations of questions generated using the parametric question. Academic integrity score provides a measure of potential randomness and uniqueness of each question of an exam. A high academic integrity score provides the possibility of generating millions or trillions of unique questions from a single parametric question template. Given a sufficiently high academic integrity score, a single parametric exam would generate unique questions for each student or candidate writing an exam for many years.

In further embodiments, the plurality of possible values is selected based on a parameter type including a list of predetermined values, a logical expression, a mathematical expression, a date, or a time. Sources of parameters could be from any of pre-programmed inventor libraries, an instructor's input, an internet search, a third party API, a public database, or any other source that can be integrated into the system. When preparing parametric questions for an exam, a user may first select a parameter type and then use a set of previously prepared lists, functions, etc. to select and configure parameters.

In further embodiments, question parameters may make use of third party APIs or public databases to integrate known data or current events into questions. For example, a question could query a public database for a real company's stock symbol, and then generate a random (fake) stock price history and P/E ratio. Question parameters may be designed deliberately to mix real-world entities and events with non-real details, such that if an exam taker answers the question based on real-world details it could signal that they are acting dishonestly by accessing answers from outside the examination platform.

In some aspects, a user interface (UI) may be used for selecting a parametric type or list. In some aspects, a user may not be needed to select the parametric type or list. In some aspects, AI or another form of automation may be used to suggest or automatically select a parametric type or list (e.g., a random company name).

In some aspects, the plurality of possible values may be selected based on a parameter type including one or more of: predetermined values, a logical expression, a mathematical expression, a date, a time, a user-defined set of values, an image, a chart based on randomized values related to the question, a map, a visual element related to content of the question, a visual element needed to answer the question, a user-uploadable dataset, and an Al generated dataset

In further embodiments, one of the plurality of parameters is generated based on a second of the plurality of parameters which allows for one parameter to depend on another.

Further embodiments include searching an online site for a text containing the question or a text matching the identifier in order to detect when a question may have been leaked online.

Further embodiments include defining a time period during which an answer to the question may be received from a candidate which allows for all candidates to write an exam or attempt a question at the same time or for exams to be generated and distributed in advance while forcing candidates to attempt the exam simultaneously. Time periods may also be used to limit the time available for a candidate to write the exam.

Further embodiments include generating a list of correct answers and a list of incorrect answers for the question. Each question can have a number of correct answers and incorrect answers and questions may be generated with different answers. Answers may be linked to parameters of the question itself and the order or answers may be randomized each time a question and answer set is generated from a parametric questions. In other words, it is possible that the correct answer to a multiple-choice question is randomly, A, B, C, or D.

In some aspects, list of parametric answers may include both incorrect and correct answers. For example, a question generated from a parametric question may indicate a number of vehicles, e.g., 1 red truck, 2 red cars, 3 blue trucks, and 3 blue cars. The possible answers for the candidate to choose from may include: a) 3 vehicles, b) 4 trucks, c) 6 cars, d) none of the above. In some aspects, in reference to the question, the parametric correct answers may be any of the following: [V_qty] vehicles, [T_qty] trucks, [C_qty] cars. In some aspects, in reference to the question, the parametric incorrect answers may be any of the following: [V_qty] trucks, [V_qty] cars, [T_qty] cars, [T_qty] vehicles, [C_qty] trucks, [C_qty] vehicles, [otherqty] . . . etc.

In some aspects, answers that may be common, such as “All of the above,” or “None of the above” may randomly appear. In some aspects, such answers may randomly become the correct answer. For example, a generated question may ask which of the following is a planet. The potential answers may include, a first variant of potential answers: a) Mars, b) Brazil, c) Moon, d) None of the above. The first variant of potential answer may have option a) Mars, as the correct answer. The first variant of potential answers may be associated with a first unique ID which may further be associated with a first test taker (e.g., a first student).

A second variant of potential answers may include: a) Brazil, b) Sun, c) Europa, d) None of the above. The second variant of potential answer may have option d) None of the above, as the correct answer. The second variant of potential answers may be associated with a second unique ID which may further be associated with a second test taker (e.g., a second student).

In further embodiments, the list of correct answers or the list of incorrect answers for the question is linked to one of the substituted values which allows additional intelligence to be used with parametric questions.

Embodiments of the present invention provides a method for administering an examination. The method includes generating an examination for each of a plurality of candidates. Each examination includes a plurality of questions and each of the plurality of questions of each of the examinations is generated by substituting one of a plurality of possible values for each of a plurality of parameters of each of the plurality of questions. Also, generating an identifier for each of the examinations by combining the substituted possible values for each of the plurality of parameters of the plurality of questions and verifying that each of the identifiers is unique. Then, sending one of the examinations to each of the plurality of candidates. In embodiments, questions and exams may be generated immediately prior to exams being taken with each candidate receiving an exam with at least one unique question that provides a unique identifier that can be used to identify the leaker of the question or its answer if it is found online.

Further embodiments include allowing one of the plurality of candidates to enter answers to one of the plurality of questions during a predefined time period.

Further embodiments include monitoring a behavior of one of the plurality of candidates as they respond to the plurality of questions and display an alert to the one of the plurality of candidates when the behavior falls outside a range of allowable behaviors. This provides the benefit of discouraging candidate cheating before it happens by flagging potentially suspicious behavior since if candidates believe that they will be caught if they cheat, they are less likely to attempt it.

Further embodiments include searching an online site for a text containing the question or a text matching one of the identifiers.

Further embodiments include utilizing a Large Language Model (LLM) to review plain-text written questions and then identify words and relationships between words and suggest parameters to replace those words, and then replace the words with actual parameters. For example, the words “ABC Company Inc.” would be replaced with a parameter “company name” which is a list of many company names. Additional example, the number $100,000 could be identified as “revenue” and replaced with a random number between $50,000 and $150,000 in increments of $5,000.

Further embodiments may check search engines to see if an instance of a question, or a non-parametric question, is publicly available, and then suggest that it be modified to include parameters or additional parameters.

Further embodiments include an interface for users to review parameters suggested by large language models to be inserted into questions, and either approve or reject the suggested insertions. Users could be the instructors responsible for the design of the exam, or teacher assistants, or third party hired laborers.

Further embodiments include evaluating exam results and assigning scores based on configuration information and question parameters. Exam results can be evaluated based on heuristic parameter logic and relationships with answers, predetermined right and wrong answers and their assigned scores, or probabilistic scores assigned by machine learning systems.

Further embodiments include an interface for users to review the analysis of exam results for accuracy. For example, an instructor can review exam result evaluations for accuracy especially in cases where the instructor designed the parameters and may have made a mistake. For another example, an instructor can review exam result evaluations for accuracy when they were determined based on probabilities assigned by a machine learning system.

Further embodiments may provide exam takers with a means to flag a parametric question that is incoherent or illogical in cases where parameters were not programmed appropriately.

Further embodiments may adjust parameters based on configuration information specific to the user, such as converting a question parameter between imperial and metric units, or utilizing lists of cities local to their country, or incorporating topics, content, or themes specific to the individual user. For example, a parameter could be populated based on content from a user's previous work in a course.

Further embodiments may determine which questions to serve an exam taker based on how they scored on previous questions. For example, an embodiment may serve an exam taker with a more difficult question that is worth more points after they answered a previous question correctly, or an easier question that is worth less points after they answered a question incorrectly.

Further embodiments may offer exam takers an option to request an easier question in exchange for a lower potential score for getting the correct answer.

The invention will now be described with reference to specific examples. It will be understood that the following examples are intended to describe embodiments of the invention and are not intended to limit the invention in any way.

### EXAMPLES

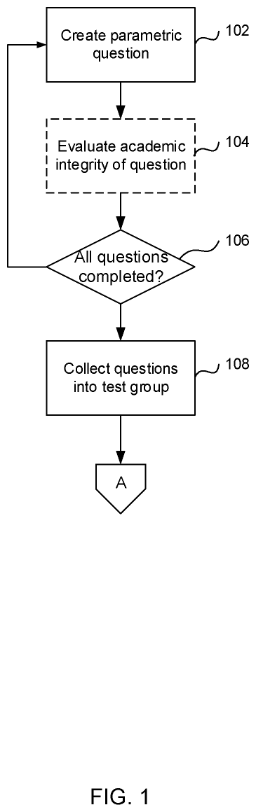

With reference to FIG. 1, embodiments may be used to define parametric questions that may later be used to generate unique questions for incorporation in exams. In step 102 a professor, teacher, or other person or persons define a parametric question using a combination of fixed text and settings. Optionally, in step 104 the question may be evaluated for academic integrity score to ensure that a sufficiently large number of unique questions may be generated using the parametric question to ensure that a sufficient number of unique questions may be generated to discourage cheating during the exam. Optionally, step 104 may also include checking search engines to see if an instance of a question, or a non-parametric question, is publicly available, and then suggest that it be modified to include parameters or additional parameters. In step 106, further parametric questions may be defined in order to have a sufficient number of questions required for the test. Pre-defined parametric questions may also be read from a database or other storage and used. If there is sufficient academic integrity score in questions, they may be reused many times without repeating the same generated question. In step 108, the parametric questions may be grouped into an exam and saved for later use. Individual questions and exams may have further configuration information assigned such as the time available to complete the exam, an earliest start time and a latest end time to take the exam, etc. Exams may also require that it be taken in a particular location as well. This configuration information may be defined when parametric questions are being defined or may be defined at a later time up until the exam is taken by a candidate.

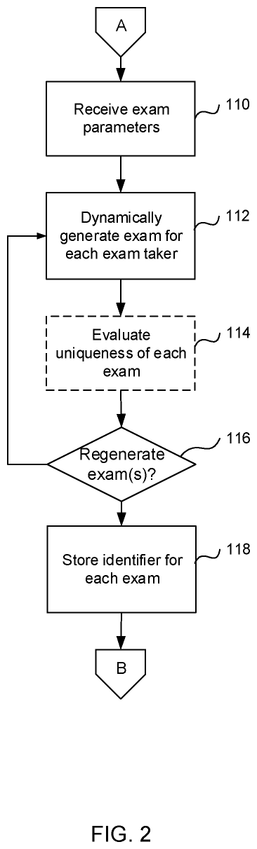

FIG. 2 illustrates a flowchart of the generations of questions and exams using parametric questions, according to an embodiment that may occur prior to an exam being administered to one or more candidates. In embodiment, though parametric questions are generated in advance, the actual questions and exams need not be and preferably are generated dynamically shortly prior to the start time of an exam. It is also possible that individual questions are not generated until a previous question has been responded to. Questions may also be generated only when an answer to a previous question is received by the system.

In step 110, the system receives exam parameters and configuration information. These parameters may include parametric questions and their answers that comprise the exam. Other data may include the number of candidates taking the exam and, therefore, the number of exams that must be generated, time and duration configuration information for the exam, and configuration information as to the required academic integrity score (uniqueness) of each exam or question, configuration information for monitoring candidates, verifying for leaked questions online, etc. In step 112, questions and exams are dynamically generated for each candidate taking the exam. In embodiments, each candidate will receive a unique exam with at least one unique question. In step 114, if configured, the academic integrity score (uniqueness) of each exam may be evaluated. In step 116, if required, exams may be regenerated, for example if two exams are found to be too similar, or if a question has been found to be leaked, etc. In step 118, an identifier for each exam, which may be based on an identifier for one or more questions of the exam may be generated and stored. As described herein, an identifier is a unique text, string, or value that may be used to identify a generated question or exam that has been leaked.

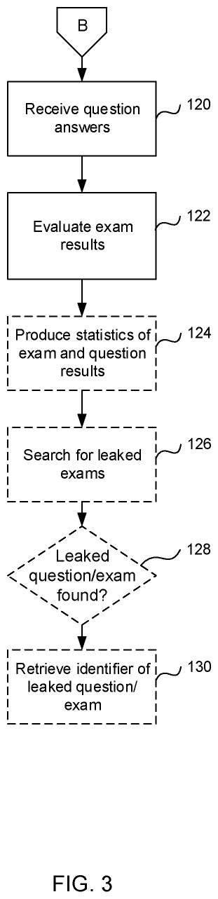

FIG. 3 illustrates a flowchart of the administrations of questions and exams using parametric questions, according to an embodiment. Once an exam has been completed, for example, answers to questions have been submitted by candidates and received by the system, time has expired, etc., in step 120 a computing device of the system may receive one or more question answers. In step 122, one or more questions may be evaluated, and a grade assigned for the question or for the exam. Optionally, in step 124 statistics of exam and question results may be generated to determine if the overall results match an expected statistical distribution, such as a normal distribution, or to determine which question is an outlier and was either too easy or too difficult, etc. Step 124 may also include evaluating exam results and assigning scores based on configuration information and question parameters. Exam results can be evaluated based on heuristic parameter logic and relationships with answers, predetermined right and wrong answers and their assigned scores, or probabilistic scores assigned by machine learning systems. Step 124 may also include an interface for users to review the analysis of exam results for accuracy. For example, an instructor can review exam result evaluations for accuracy especially in cases where the instructor designed the parameters and may have made a mistake. For another example, an instructor can review exam result evaluations for accuracy when they were determined based on probabilities assigned by a machine learning system. Step 124 may also include evaluating the time it took an exam taker to complete a question and that question's relative difficulty to determine a risk score that the exam taker answered the question via dishonest means. In step 126, an online search for leaked exams may be conducted using search or web crawling techniques. In step 128, If an exam or exam question is found online, in step 130 the identifier can be used to determine which candidate's exam or question was leaked and appropriate action taken.

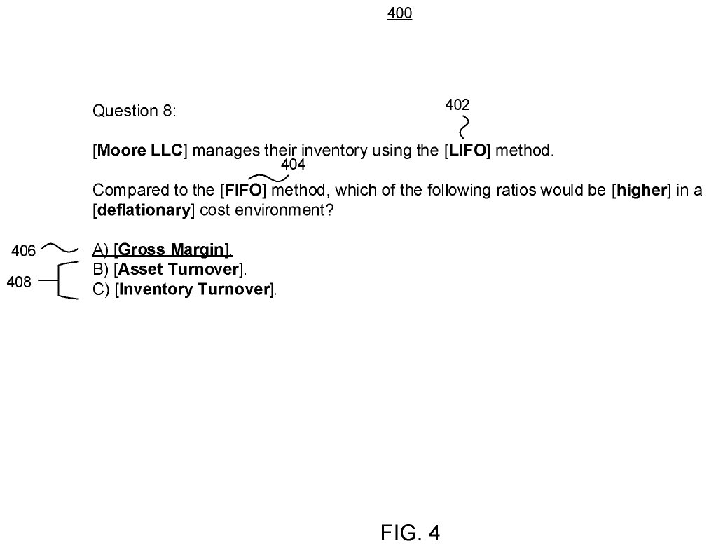

FIG. 4 illustrates a parametric question 400, according to an embodiment. Parametric question 400 may be produced, programmed, or scripted by a user of a computing device accessing a graphical user interface. In embodiments, other methods may be used to define parametric question 400 such as file types such as XML, scripting languages, automatically generating a parametric question 400 from one or more exemplary questions, etc. As an example, a professor may import an existing exam and the system may parse the question to produce parametric questions of one or more written questions of the existing exam.

FIG. 4 illustrates an exemplary “question 8” which is a multiple choice question with 3 choices. The question itself includes plain text such as, “manages their inventory using the,” and five parameters; “Moore LLC” (a company name), “LIFO” 402 and “FIFO” 404 (an accounting method of tracking costs), “higher” (a relative term), and “deflationary” (an economics term). The company name, the first parameter, may be selected from a list of real or imaginary companies, the first appearance of “LIFO”, the second parameter, may be selected from a list containing terms such as {LIFO, FIFO}. The appearance of “FIFO”, the third parameter, may be linked to the second parameter (e.g., in this case “LIFO” 402) so that if “FIFO” is selected for the second parameter, “LIFO” is automatically selected for the third parameter and vice versa. The term “higher”, the fourth parameter, is a relative term which may be selected from another list and may be linked to one or more of: the second parameter, the third parameter, and the fifth parameter. The term “deflationary”, the fifth parameter, may also be selected from a list but may also be linked to the previous choice of “LIFO” or “FIFO”.

As this is a multiple-choice question, correct answer 406 may be chosen from a list of possible correct answers and linked to the any one or more of the other questions by defining a logical relationship. Incorrect answers 408 may also be chosen from a list or linked to the correct answer or to any one or more of the question parameters.

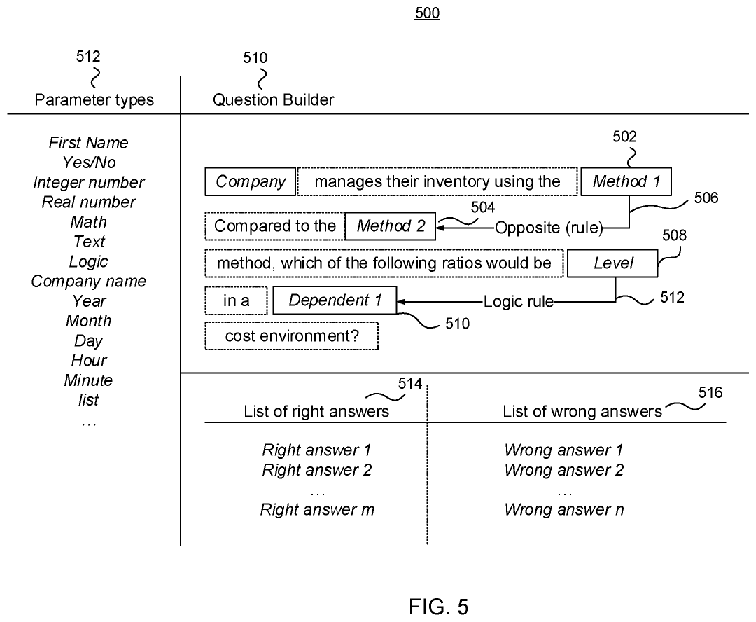

FIG. 5 illustrates a computer graphical user interface (GUI) 500 for the creation of a parametric question, according to an embodiment. A question builder section 510 allows a user to input text (in dotted boxes) and parameter/variables (in solid boxes) using text, menu driven, drag and drop and other GUI manipulation techniques. A parameter/variable section 512 of the GUI allows a user to filter or select parameter types. Selecting or “right clicking” on a box or parameter type may bring up a pop-up menu or dialog box to allow a user to configure a parameter, for example by linking parameters, selecting possible values, selecting, or defining a list of values, selecting a range, minimum, maximum, etc. of a parameter, etc. A user may also define a list of right answers 514 and a list of wrong answers 516. Rules between parameters such as an “opposite” rule between method 1 502 and method 2 504 or “logic” rule 512 between level 508 and dependent 1 510 may also be defined. Similarly, rules (not illustrated) between parameters and answer lists 514 and 516 may also be defined. The GUI 500 may also be used to edit, add, delete, or otherwise manage the parametric question.

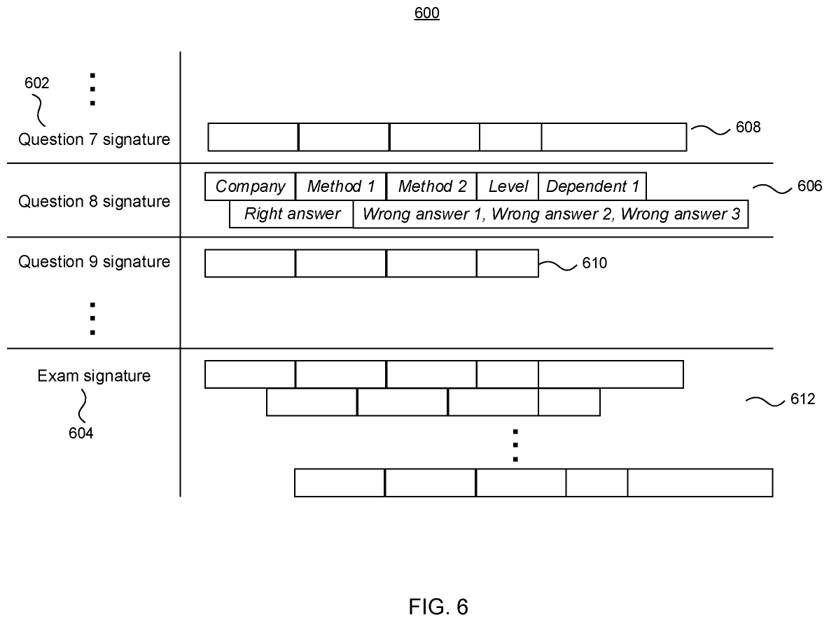

FIG. 6 illustrates the creation of an identifier for questions and exams, according to an embodiment. As questions are generated, as in step 112 of FIG. 2, parameters of a parametric question are replaced or substituted by values to form questions that are included in exams. Given a sufficient academic integrity score of the type and number of parameters, the values they may take, and the possible right and wrong answers defined, an arbitrarily large number of unique questions may be generated. By combining the substituted values 606, 608, and 610, an identifier 602 may be produced that may be unique. As well, a combination of question signatures 602 may be used to produce an exam signature 604 that may also be unique. These signatures may be concatenated to form a text string 606 that may be used as an identifier. Other methods may also be used to produce question signatures 602 and exam signatures 604 from the values 606 including producing a hash of the values or using cryptographic techniques. If a question or entire exam is leaked online an identifier for the leaked information may be calculated and compared to a database of identifiers of generated questions and exams to determine who leaked the information.

Embodiments may make use of tactical deterrents that discourage students from cheating in real time or in a timely manner. As a student takes an exam, keyboard pattern and mouse movement tracking may be used to predict and detect potential cheating behaviors, such as leaving the browser, print detection, screenshot detection, and pasting text. When such behavior is detected, the student may be immediately notified of misbehavior and this notification may psychologically deter them from performing that behavior again. Misbehavior may also be reported to a teacher, professor, invigilator, etc. as required. That students know that they may be reported for cheating behaviors acts as a strong deterrent from ever performing those behaviors in the first place.

Embodiments may make use of leaked content tracking on the question or exam level. A leaked content tracking service may crawl the Internet and find leaked questions and exams that correspond to generated questions. Since each question or exam identifier may be unique this allows for the identification of the student or party who leaked the content and provide evidence for disciplinary action. If students are aware that this feature is available it acts as a strong deterrent to them leaking content, as they know there is a strong possibility of being caught, and as a strong deterrent against searching for exam answers online, as they know that they are highly unlikely to find the answers.

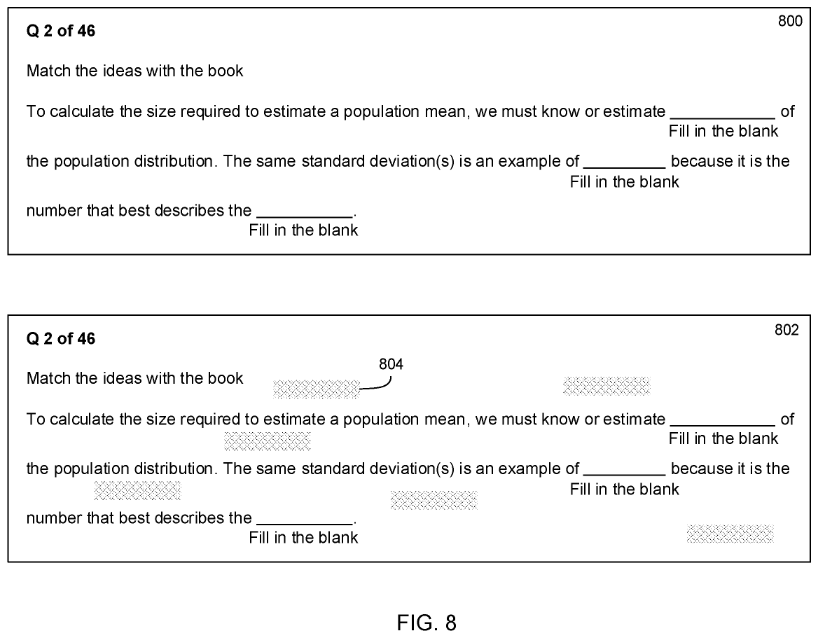

As may be appreciated by a person skilled in the art, in some aspects, one or more techniques may be used for determining whether a question or exam has been leaked. In some aspects, digital fingerprint or variations thereof may be used to determine leaked content. Some techniques for achieving a digital fingerprint may include: Consideration of the unique variable permutations of the parametric question, randomly adding an extra space inside a question; intentionally misspelling common words like “neighbor”; leveraging punctuation, such as adding an extra period or removing one at the end of a line break; randomly capitalizing keywords, e.g., “Accounting vs accounting” and “Straight Line Depreciation vs straight line depreciation”. Digital fingerprints may further be achieved via one or more of: randomly changing spaces to white-colored hyphens, so when a student copy, pastes or both, the student may not realize the white-colored hyphens and leave it as is; randomly selecting from a variety of similar fonts, such as Arial and Arial New or Open Sans Pro and Open Sans; randomly changing the font color to imperfect black, which to human eye maybe undetectable (e.g., RBG 0,0,0 to RGB 2,3,1); and adding a watermark of pixels that may be, and or may not be, detectable to the human eye, such as pixels that may be just off of perfect white (e.g., RBG 254,254,254) in random spots for when students screenshot). An example of white pixel is illustrated in FIG. 8 and further described herein.

Embodiments may allow for parametric questions to incorporate multi-step questions that allow instructors to build questions that mimic an online document editor such as Microsoft Word and Google Docs. This approach allows instructors to add unlimited question prompts (aka steps) of any supported type (e.g., Multiple Choice, Multiple Answers, Matching, Fill in the Blank, Short Answer, etc.) in a question without being constrained by a pre-scripted template.

Embodiments may allow parametric questions that include error carry forward auto grading features that allows for the generation of exam questions that allow for “error carry forward” grading. Error carry forward grading may be based on multi-step questions in which a candidate's answers to a first question may affect the variables of the one or more subsequent questions. For example, a first generated question may ask to calculate depreciation, and a second generated question may further ask to calculate an ending balance on the balance sheet, which requires a correct answer to the generated first question. In some aspects, error carry forward grading may be employed, in which the answer to the first question, the calculated depreciation answer, may be used for adjusting the grading for the second question (i.e., the ending balance on the balance sheet).

Using error carry forward grading, a student's answer that is in error may be carried forward for subsequent auto-grading and the student isn't penalized twice for making a mistake in longer, multi-step questions. This feature offers real advantages in areas such as accounting where the value of one question may be used in subsequent follow-on questions. This technology may be enabled by using customized random seeding that provides deterministic randomization so that re-calculating of random variables during grading returns the same values generated during question building.

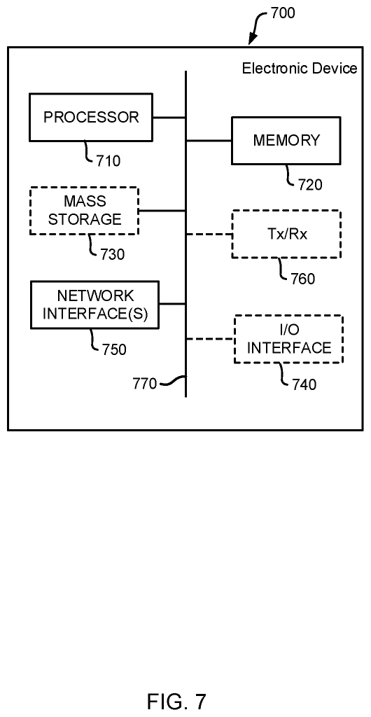

FIG. 7 is a block diagram of an apparatus or an electronic device 700 that may be used to perform embodiments or portions of methods of embodiments of the present disclosure as described herein. For example, real or virtual computers, servers, cloud computing infrastructure, web servers, etc. can be configured as the electronic device. It is also noted that computing devices directing operations of embodiments of the present disclosure may include microcontrollers or microprocessors which execute program instructions stored in-memory, or other digital or analog circuitry, or a combination thereof.

As shown, the device includes a processor 710, such as a Central Processing Unit (CPU) or specialized processors such as a Graphics Processing Unit (GPU) or other such processor unit, memory 720, non-transitory mass storage 730, I/O interface 740, network interface 750, and a transceiver 1760, all of which are communicatively coupled via bi-directional bus 770. According to certain embodiments, any or all of the depicted elements may be utilized, or only a subset of the elements. Further, the device 700 may contain multiple instances of certain elements, such as multiple processors, memories, or transceivers. Also, elements of the hardware device may be directly coupled to other elements without the bi-directional bus.

The memory 720 may include any type of non-transitory memory such as static random access memory (SRAM), dynamic random access memory (DRAM), synchronous DRAM (SDRAM), read-only memory (ROM), any combination of such, or the like. The mass storage element 730 may include any type of non-transitory storage device, such as a solid state drive, hard disk drive, a magnetic disk drive, an optical disk drive, USB drive, or any computer program product configured to store data and machine executable program code. According to certain embodiments, the memory 720 or mass storage 730 may have recorded thereon statements and instructions executable by the processor 710 for performing any of the aforementioned method steps described above.

FIG. 8 illustrates an example of a digital fingerprint according to an embodiment. The digital fingerprint achieved in FIG. 8 may be based on one or more pixel watermark 804. In an aspect, a question may be generated using a parametric question. The question may use white pixels 804, among other techniques described herein or known by a person skilled in the art, to indicate a digital fingerprint that may be undetectable to the human eye. Accordingly, a candidate answering the generated question may see the question illustrated according to reference label 800, whereas, question 802 illustrates the question as viewed by a computer indicating the plurality of pixel watermarks 804. As may be appreciated by a person skilled in the art, one or more techniques or combinations may be used to establish a digital fingerprint. In some aspects, the digital fingerprint may be unique for each question, combination of questions (in a case of an exam). In some aspects, the digital fingerprint may serve as the unique ID or be associated with the unique ID of the question.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Actions associated with methods described herein can be implemented as coded instructions in a computer program product. In other words, the computer program product is a computer-readable medium upon which software code or instructions is recorded to execute the method when the computer program product is loaded into memory and executed on a processor of a computing device.

Further, each operation of the method may be executed on any real or virtual computing device, such as a personal computer, server, tablet, smartphone, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Unless defined otherwise, all technical and scientific terms used herein have the same meaning as commonly understood by one of ordinary skill in the art to which this invention belongs.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for generating an examination question comprising:
defining a parametric question template including a plurality of parameters, each of the plurality of parameters having a plurality of possible values;
receiving a request to generate a plurality of examinations utilizing the parametric question;
generating a question by substituting one of the plurality of possible values for each of the plurality of parameters; and
generating an identifier of the question including a combination of the substituted possible values for each of the plurality of parameters of the question.

2. The method of claim 1 further comprising evaluating the parametric question to determine an academic integrity score based on a number of possible permutations of questions generated using the parametric question.

3. The method of claim 1 wherein the plurality of possible values is selected based on a parameter type including one or more of: predetermined values, a logical expression, a mathematical expression, a date, a time, a user-defined set of values, an image, a chart based on randomized values related to the question, a map, a visual element related to content of the question, a visual element needed to answer the question, a user-uploadable dataset, and an AI generated dataset.

4. The method of claim 1 wherein one of the plurality of parameters is generated based on a second of the plurality of parameters.

5. The method of claim 1 further comprising searching an online site for a text containing the question or a text matching the identifier.

6. The method of claim 1 further comprising defining a time period during which an answer to the question may be received from a candidate.

7. The method of claim 1 further comprising generating a list of correct answers and a list of incorrect answers for the question.

8. The method of claim 7 wherein the list of correct answers or the list of incorrect answers for the question is linked to one of the substituted values.

9. A method for administering an examination comprising:
generating an examination for each of a plurality of candidates, the examinations including a plurality of questions, each of the plurality of questions of each of the examinations being generated by substituting one of a plurality of possible values for each of a plurality of parameters of each of the plurality of questions;
generating an identifier for each of the examinations by combining the substituted possible values for each of the plurality of parameters of the plurality of questions;
verifying that each of the identifiers is unique; and
sending one of the examinations to each of the plurality of candidates.

10. The method of claim 9 further comprising allowing one of the plurality of candidates to enter answers to one of the plurality of questions during a predefined time period.

11. The method of claim 9 further comprising:
receiving, from each of the plurality of candidates, one or more answers to each examination; and
grading each of the plurality of candidates, based on the received one or more answers.

12. The method of claim 11, wherein grading each of the plurality of candidates, based on the received one or more answers comprises grading based on error-carry forward grading.

13. The method of claim 9 further comprising:
monitoring a behavior of one of the plurality of candidates as they respond to the plurality of questions; and
display an alert to the one of the plurality of candidates when the behavior falls outside a range of allowable behaviors.

14. The method of claim 9 further comprising:
searching an online site for a text containing the question or a text matching one of the identifiers.

15. An apparatus comprising:
at least one processor and at least one machine-readable medium storing executable instructions which when executed by the at least one processor configure the apparatus for:
defining a parametric question template including a plurality of parameters, each of the plurality of parameters having a plurality of possible values;
receiving a request to generate a plurality of examinations utilizing the parametric question;
generating a question by substituting one of the plurality of possible values for each of the plurality of parameters; and
generating an identifier of the question including a combination of the substituted possible values for each of the plurality of parameters of the question.

16. The apparatus of claim 15, wherein the at least one processor further configures the apparatus for: evaluating the parametric question to determine an academic integrity score based on a number of possible permutations of questions generated using the parametric question.

17. The apparatus of claim 15, wherein the plurality of possible values is selected based on a parameter type including one or more of: predetermined values, a logical expression, a mathematical expression, a date, a time, a user-defined set of values, an image, a chart based on randomized values related to the question, a map, a visual element related to content of the question, a visual element needed to answer the question, a user-uploadable dataset, and an AI generated dataset.

18. The apparatus of claim 15, wherein one of the plurality of parameters is generated based on a second of the plurality of parameters.

19. The apparatus of claim 15, wherein the at least one processor further configures the apparatus for: searching an online site for a text containing the question or a text matching the identifier.

20. The apparatus of claim 15, wherein the at least one processor further configures the apparatus for: defining a time period during which an answer to the question may be received from a candidate.

21. The apparatus of claim 15, wherein the at least one processor further configures the apparatus for: generating a list of correct answers and a list of incorrect answers for the question.

22. The apparatus of claim 21, wherein the list of correct answers or the list of incorrect answers for the question is linked to one of the substituted values.

23. An apparatus comprising:
at least one processor and at least one machine-readable medium storing executable instructions which when executed by the at least one processor configure the apparatus for:
generating an examination for each of a plurality of candidates, the examinations including a plurality of questions, each of the plurality of questions of each of the examinations being generated by substituting one of a plurality of possible values for each of a plurality of parameters of each of the plurality of questions;
generating an identifier for each of the examinations by combining the substituted possible values for each of the plurality of parameters of the plurality of questions;
verifying that each of the identifiers is unique; and
sending one of the examinations to each of the plurality of candidates.

24. The apparatus of claim 21, wherein the at least one processor further configures the apparatus for: allowing one of the plurality of candidates to enter answers to one of the plurality of questions during a predefined time period.

25. The apparatus of claim 21, wherein the at least one processor further configures the apparatus for:
receiving, from each of the plurality of candidates, one or more answers to each examination; and
grading, each of the plurality of candidates, based on the received one or more answers.

26. The apparatus of claim 25, wherein the configuration for grading, each of the plurality of candidates, based on the received one or more answers comprises further configure the apparatus for grading based on error-carry forward grading.

27. The apparatus of claim 21, wherein the at least one processor further configures the apparatus for:
monitoring a behavior of one of the plurality of candidates as they respond to the plurality of questions; and
display an alert to the one of the plurality of candidates when the behavior falls outside a range of allowable behaviors.

28. The apparatus of claim 21, wherein the at least one processor further configures the apparatus for: searching an online site for a text containing the question or a text matching one of the identifiers.
